(19) United States
(12) Patent Application Publication
(10) Pub. No.: US 2005/0102172 A1
(43) Pub. Date: May 12, 2005

(54) System and method for evaluating insurance member activity and pricing insurance products

(76) Inventor: James R. Sirmans JR., Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/974,186

(22) Filed: Oct. 27, 2004

Related U.S. Application Data
(60) Provisional application No. 60/516,075, filed on Oct. 31, 2003.

(51) Int. Cl. G06F 17/60

(52) U.S. Cl. 705/4

(57) ABSTRACT

The present invention relates to systems and methods for evaluating and establishing pricing of insurance products based on insured member compliance to health-promoting measures. Member participation in health-promoting measures are monitored and used as a basis for establishing incentives (i.e., reduction in insurance premiums) for said member. In one embodiment, exercise/activity monitors are worn by members to verify their identity and to record insurance member compliance in performing health-promoting measures (i.e., heart rate, type of exercise, exercise intensity and duration). All health-related information, including physical examination results and recorded participation in health-promoting measures, are used to determine appropriate incentives (i.e., subsidize membership fees for health club) to be rewarded to said member.

### CROSS-REFERENCE TO A RELATED APPLICATION

This application claims the benefit of provisional patent application Ser. No. 60/516,075, filed Oct. 31, 2003, which is hereby incorporated by reference in its entirety.

### FIELD OF THE INVENTION

The present invention relates to a system and method for evaluating and providing insurance products based on continuous monitoring of subscriber compliance with health-promoting measures.

### BACKGROUND OF THE INVENTION

Health care costs have risen steadily over the years. Controlling health care costs are mandatory for everyone, including businesses. For example, employers that contribute to employee insurance have seen dramatic increases in insurance premiums. Responsible managers in business need to develop systems to manage the optimal health of their employees, not only to save costs but also to save lives. Unfortunately, there is currently little that an employer can do to encourage employees to minimize medical expenses and/or to adopt a healthy lifestyle.

The traditional paradigm of insurance for health care services rendered is based on the current health care model of treating symptoms of pain and/or dysfunction only after presentation in the patient. Thus, indemnification is provided after “pain/illness” occurs, which results in a costly, non-viable model for benefit delivery. Moreover, insured members often attempt to draw the maximum possible benefits. (maximal use of health care service/providers) from their insurance packages due to a belief that contributions to the insurance package would otherwise be “wasted.” Insurers have failed to recognize that the number of “pain/illness” occurrences can be decreased if members were provided incentives to perform health-promoting measures that would optimize their health/wellness (i.e., proper nutrition, exercise).

Studies have shown that costs related to excess medical utilization can be significantly reduced by proactively preventing detectable health risks, which are likely to become insurance claims. For example, “sustainable” exercise programs have been proven to dramatically improve an individual's health (morbidity) by reducing the incidence of sickness and/or injury, thus resulting in a longer life (improved mortality).

Moreover, the frequency of doctor visits or frequency of medication prescription varies statistically from persons who regularly exercise and make an effort to maintain their physical and mental health versus persons who do not do so. For example, individuals who regularly exercise and/or make an effort to maintain their health incur fewer medical expenses (i.e., fewer doctor visits, fewer medications) than an individual who does not exercise. Unfortunately, once insured, members may become apathetic in their efforts in maintaining a healthy lifestyle due to a view that any health related issues would be covered by insurance.

The existing insurance system ignores efforts by individuals to maintain their own health and wellness on a day-to-day basis. What is generally considered when a person applies to join an insurance plan are criteria such as the prospective member's age, sex, and data concerning the individual's past history. However, the insurance company does not take into account those “healthy” members who become apathetic in their efforts in maintaining their health as a result of a belief that any future health care costs would be covered by insurance.

Moreover, current insurance products lack control measures that assure member compliance with specified health measures for promoting health/wellness. Underwriting and pricing of insurance coverage is presently done at the time of application with eligibility for coverage based on data and representations from the member. Further, “lifestyle” issues such as smoking and alcohol consumption are taken at face value based on the member's representations. Members have little incentive to participate in health-promoting measures. Moreover, there are few measures available to verify the truthfulness of member representations or review member activities related to health/wellness on an on-going basis. Thus, a new insurance paradigm is needed to not only address caring for the sick but to also promote and reward fitness/wellness.

A system and method for monitoring individual efforts in maintaining health, which is reflected in their insurance premium, has been described in Japanese Patent No. 2002263071. The invention concerns insurance premiums that are discounted according to certain reported health-related activities performed by a customer, including utilization frequency by a customer of a sport club. However, recording the number of times a person attends a sports club does not accurately assess whether a person has performed any exercise activity, if at all. Moreover, it is not inconceivable that a member, in order to receive the insurance premium discount, would get another individual to impersonate him and create a spurious sports club attendance file.

Another method of monitoring health and discounting insurance premiums is provided in U.S. Patent Application Serial No. 2002/0013717. This invention concerns a portable, individualized exercise monitor that functions to assess user exercise activity as well as user identity. The monitor is designed to be connected to the body of the user, i.e., a pedometer, and includes a means for checking the identity of the person wearing the monitor. Unfortunately, this system can be very intrusive to an individual and be distracting during exercise activities. Moreover, the monitoring devices do not provide routine-specific identity (i.e., the specific exercise activity being performed, the specific muscle groups being impacted).

Other insurance savings schemes have been proposed in which members claim benefits at a lower rate than normal and/or can accrue funds in a savings account. These schemes, however, do not provide an incentive for members to maintain healthy lifestyles nor do they include a means for accurately monitoring an individual's compliance with requisite exercise/health activities for maintaining health and wellness.

### BRIEF SUMMARY OF THE INVENTION

The subject technology provides a system for monitoring an insurance member's performance of health-promoting measures. According to the present invention, verifiable data regarding member performance of health-promoting measures are then provided to insurance carriers on an on-going basis (such as a computerized continuous data management system). Should members perform health-promoting measures that meet or exceed established protocol criteria (for example, standards of performance with established health-promoting measures as prescribed), members will then qualify for financial incentives (such as discounted premiums and/or benefit incentives). According to the present invention, the financial incentives/benefits can be withdrawn should members fail to meet established protocol criteria (for example, a member falls short of prescribed, pre-determined levels of performance).

In accordance with the present invention, systems and methods for assessing member history (i.e., medical history & lifestyle) and/or member compliance in participating in health-promoting measures (i.e., exercise regimen) are provided. Financial incentives to participate in insurance programs based on the subject invention include, financial incentive features (i.e., reduction of insurance premiums based on member compliance with prescribed performance protocol regimen), and payment or reimbursement of costs related to the participation in activities designed to promote health/wellness (i.e., reimbursement for health club membership, reimbursement for weight loss program membership).

The present invention provides systems and methods for promoting health/wellness and methods for discounting insurance premiums based on insurance member compliance thereof. In one embodiment, an exercise machine is equipped with a means for monitoring exercise activity. In a related embodiment, the exercise machine includes a means for monitoring individual identity; historical exercise activity; type of exercise, exercise intensity, and exercise duration; as well as physiological measurements (i.e., resting, activity, and recovery heart rates and pulse, blood pressure, temperature).

In another embodiment, a personal monitoring device is provided to an insurance member, wherein the monitoring device is equipped with a means for continuous monitoring of member physiological status. Physiological data that can be monitored using a monitoring device of the subject invention include, but are not limited to, body core temperature, galvanic skin response, pulse, blood pressure, respiration, activity, heat flow, and certain electrical currents associated with electrocardiogram and electroencephalograph measurements. The personal monitoring device of the subject invention is preferably adapted to generate and provide feedback to a gatekeeper and/or insurance provider relating the degree to which an insurance member has complied with a health promoting measure.

Based on the recorded participation in health-promoting measures (i.e., exercise activity) and other health information (i.e., improvement in medical condition/health), respective financial incentives (also referred to herein a rewards) are allocated to the insurance member. In one embodiment, the reward is a decrease in premium payments, subsidized payment of fees associated with performing health-promoting measures (i.e., membership fees to a sports club, or subsidized payment of the exercise machine); and/or increased benefits payment according to a predetermined scheme.

In accordance with the subject technology, a statistical data management continuum file is established for each insured member, in which the member's vital health statistics and prescribed exercise regimen are profiled, tracked, and stratified into a performance model based on protocol criteria.

In one embodiment, these protocol criteria are entitled, “Fitness Index Ratings.” The member is offered various levels of “performance” criteria, in which each level is associated with a specific financial incentive (i.e., discount). Based on the chosen performance level, the member's compliance is monitored. For example, the member's historical attendance at a health club, along with the member's specific exercise regimen/performance data including, but not limited to, type of exercise performed; intensity level (calories burned), and duration, are documented, recorded, and communicated onto a computer-based system. The cumulative results from the member's performance data are then summarized into a legend. The legend provides a protocol compliant assessment summary that can be used to assess if and how much of a financial incentive will be provided to the member. This summary can be periodically transmitted to an insurer for continuous coverage assessment.

In a preferred embodiment, the health-promoting measure can include specific exercise regimens to be performed in, or out of a health club. In a related embodiment, the individual wears a subscriber monitoring device which uniquely identifies the user, then gathers and relays data on subscriber compliance and performance with regard to the chosen health promoting regimens (i.e., exercise regimens). The data from a personal monitoring device can then be relayed to a gatekeeper and/or insurance provider.

Where the data from the personal monitoring device is provided to the gatekeeper, this data can be analyzed and evaluated as to efficacy of member performance prior to providing it to an insurer, in order to justify the awarding of financial incentives for the insurance member. In another embodiment, the data is communicated directly to an insurance carrier to process an appropriate reward to a member who has met minimal acceptable stands of performance of health-promoting measures.

The invention can be implemented in numerous ways, including as a system (including a computer processing system, monitoring technology, and means for sensing member physiological status), a method (including a computerized method of statistically analyzing member physiological status data), an apparatus, a computer readable medium, a computer program product, or a data structure tangibly fixed in a computer readable memory. Several embodiments of the invention are discussed below.

As a COMPUTER SYSTEM, an embodiment of the invention includes a communications interface for receiving data input (i.e., from a sensor) regarding member activity, a database or other storage means, a display device and a processor unit. The display device has a plurality of display areas (windows). The processor unit operates to receive recognized data from a monitoring device and/or exercise machine communicated therefrom into a database (or other text based program) of the computer system.

As a METHOD of data entry and analysis, an embodiment of the invention includes the operations of: (a) receiving data regarding member activity via commonly available communication means (i.e., digital internet, etc.); (b) statistically analyzing the data to track and provide a profile of member activity; and (c) assessing the analyzed data to identify financial incentives.

As a COMPUTER READABLE MEDIA containing program instructions for data entry, an embodiment of the invention includes: computer readable code devices for (a) receiving member activity via communication means; (b) statistically analyzing the data to track and provide a profile of member activity; and (c) assessing the analyzed data to identify financial incentives.

The methods of the present invention may be implemented as a computer program product with a computer-readable medium having code thereon. The program product includes a program and a signal bearing media bearing the program.

Thus, the present invention provides the foundation on which an insurer can justify providing financial incentives (i.e., reducing premiums and subsidizing health club memberships) to encourage members to adopt and/or continue with health/wellness activities.

### BRIEF DESCRIPTION OF THE DRAWINGS

FIG. 1 is a flow chart illustrating the steps of evaluating an insurance product based on member performance of health-promoting measures according to the present invention.

### DETAILED DISCLOSURE OF THE INVENTION

The subject technology provides a system and method for providing to insurance carriers verifiable data regarding member performance of health-promoting measures, on an on-going basis. Members qualify for financial incentives (such as discounted premiums and/or benefits) based on whether certain minimal acceptable standards of performance (also referred to herein as protocol criteria) in adopting and/or maintaining health-promoting measures are met, as prescribed by the insurance carriers. This, in turn, will make insurance coverage more cost-effective, more accessible to prospective members (lower cost), and will promote healthier members.

As used herein, the term “health-promoting measures,” refers to recordable and/or verifiable activities that are designed to improve and/or maintain individual health/wellness. Examples of health-promoting measures as contemplated herein include, and are not limited to, exercise regimens (i.e., weight training, aerobic exercises (i.e., jogging, bicycling)); programs designed to improve wellness (i.e., yoga, smoke-ending courses, weight control courses); wellness visits to the physician (i.e., annual breast exam; prostate examination); and preventive care (i.e., vaccinations, pap smears).

The term “gatekeeper,” as used herein, refers to an entity that continuously manages recorded data of monitored member performance of health-promoting measures. In a preferred embodiment, the gatekeeper profiles, tracks, and stratifies the recorded data into a performance model based on previously established protocol criteria regarding health-related measures. The gatekeeper will summarize and provide the results of the performance model to an insurance carrier, which can then determine member eligibility for rewards.

Specifically, the present invention provides systems and methods for assessing member health, which include but are not limited to, assessing the insurance member's medical history, lifestyle, and member subscription to health-promoting measures (i.e., exercise regimen). Financial incentives to participate in such insurance policies include, but are not limited to, financial incentive features in which premiums are reduced based on member compliance with a prescribed performance/protocol regimen, payment/reimbursement of costs related to member participation in such protocol (i.e., reimbursement for health club membership, payment for membership with Weight Watchers).

In one embodiment, the health-promoting measure to be monitored is the use of an exercise machine by an insurance member. Any exercise machine that is commonly used to promote fitness is suitable for the present invention. Contemplated exercise machines include, by way of example, stationary bicycles, stair climbers, steppers, rowing machines, ski machines, treadmills, cross trainers, hiking machines, abdominal exercise machines, elliptical exercise machines, and strength-training and weight machines. According to the subject invention, such exercise machines include a terminal that communicates with a central computer of the invention.

In another embodiment, the health-promoting measure(s) to be monitored in accordance with the subject invention is member physical activity. Any personal monitoring device that can monitor member physiological status is suitable for the present invention. Contemplated personal monitoring devices include, by way of example, those disclosed in U.S. Pat. Nos. 6,635,015; 6,605,038; 6,595,929; and 6,527,711 (collectively assigned to BodyMedia, Inc.). According to the subject invention, such personal monitoring devices include at least one sensor for the detection of physiological status data and a transmitter that is adapted to take data provided by the sensor(s) and transmitting the same to a central computer of the invention.

In accordance with the present invention, data provided by an exercise machine and/or monitoring device are transmitted to a central computer of the invention. A central computer of the invention records and processes data provided by the monitoring device and/or exercise machine worn by the user. The central computer can be continuously accessed by a gatekeeper to profile, track, and stratify the data into a performance model based on pre-established criteria for health-promoting measures. Alternatively, the insurance carrier can access the central computer directly to determine member eligibility for financial incentives, provided the member has performed a minimum number of health-promoting measures.

The central computer, according to the subject invention, can be housed within a facility that is remotely located from the insurance carrier or can be housed with the insurance carrier. In a preferred embodiment, the central computer is housed within an insurance carrier facility while a patient performs health-promoting measures at a remotely located location from the insurance carrier.

Preferably, the central computer of the invention comprises a central processing unit (CPU) having sufficient processing power to perform program codes and algorithm operations in accordance with the subject invention. The program codes and algorithm operations, including the statistical data management continuum program and filtering, analysis, and monitoring operations, can be embodied in the form of computer processor usable media, such as floppy diskettes, CD-ROMS, zip drives, non-volatile memory, or any other computer-readable storage medium, wherein the computer program code is loaded into and executed by the central computer. Optionally, the program codes and/or operational algorithms of the subject invention can be programmed directly onto the CPU using any appropriate programming language, preferably using the C programming language.

The central computer can also include a neural network for pattern recognition. Artificial Neural Networks ANNs are self learning; the more data presented, the more discriminating the instrument becomes. By running many standard samples and storing results in computer memory, the application of ANN enables the device to “understand” the significance of the monitored member performance of health-promoting measures better and to use this information for future analysis (for example, to analyze whether a member is getting healthier). “Learning” is achieved by varying the emphasis, or weight, that is placed on the output of one monitored health-promoting measure versus another. The learning process is based on the mathematical, or “Euclidean,” distance between data sets. Large Euclidean distances represent significant differences in sample-to-sample aroma characteristics.

In certain embodiments, the central computer comprises a memory capacity sufficiently large to perform program codes and/or algorithm operations in accordance with the subject invention. The memory capacity of the invention can support loading a computer program code via a computer-readable storage media, wherein the program contains the source code to perform the program codes and/or operational algorithms of the subject invention. Optionally, the memory capacity can support directly programming the CPU to perform the operational algorithms of the subject invention. A standard bus configuration can transmit data between the CPU, memory, ports and any communication devices.

In addition, as understood by the skilled artisan, the memory capacity of the central computer can be expanded with additional hardware and with saving data directly onto external mediums including, for example, without limitation, floppy diskettes, zip drives, non-volatile memory and CD-ROMs.

The central computer can further include the necessary hardware and software to provide analyzed monitored information into an output form readily accessible by the insurance carrier, trained physician, technician, or insurance member. For example, without limitation, an audio device in conjunction with audio speakers can relay monitored and analysis results into an audio signal, and/or a graphical interface can display results in a graphical form on a monitor and/or printer. Further, the central computer can also include the necessary software and hardware to receive, route and transfer data to and from a remote location in which the portable device is in use.

More than one exercise terminal and/or monitoring device can communicate with the central computer of the invention at any time to form a network. The network can be arranged as a local area network (LAN), a wide area network (WAN), or a wireless network. Communications between terminals and/or monitoring devices and the central computer can be provided via coaxial cable, a twisted pair, optical fiber, or any other conventional communications link.

A variety of highly sophisticated exercise machines that include terminals that can communicate to a central computer have been developed. For example, U.S. Pat. No. 6,447,424 describes hiking machines, treadmills, and the like, which include displays of mountainous terrain to provide visual enjoyment to the user while exercising. Such exercise machines can be used in accordance with the subject invention to communicate directly with a central computer or by synchronizing data to the member worn monitoring device.

An exercise machine preferably includes a means for recording the identity of the individual using the exercise machine and a means for monitoring an individual using the machine. The exercise machine preferably monitors the type of exercise being performed by the individual, the intensity and duration of the exercise activity, as well as physiological conditions such as heart rate or blood pressure, caloric energy expended, or number of steps taken. The means for monitoring an individual using an exercise machine and recording the identity of the individual can be based on known computerized devices and sensors, such as those disclosed in U.S. Pat. Nos. 6,458,060; 6,059,692; 6,053,844; 6,050,924; 6,033,344; 6,014,432; and 5,967,975.

In yet another embodiment, a monitoring device of the invention includes a means for recording the identity of the individual wearing the monitoring device and at least one sensor for monitoring the physiological status of the member wearing the monitoring device. The sensor(s) of the monitoring device can preferably monitor the type of exercise being performed by the individual, the intensity and duration of the exercise activity, as well as physiological conditions such as heart rate or blood pressure, caloric energy expended, or number of steps taken. The sensor(s) for monitoring physiological status data of an individual and the means for recording the identity of the individual can be based on known monitoring devices and sensors, such as those disclosed in U.S. Pat. Nos. 6,635,015; 6,605,038; 6,595,929; and 6,527,711 (collectively assigned to BodyMedia, Inc.). In addition to monitoring exercise regimens, the present invention also provides methods for monitoring health-promoting measures that are not related to exercise. In one embodiment, member participation in activities dedicated to, without limitation, improving or maintaining mental and emotional balance and health (i.e., relaxation/stress-reducing activities); relationship wellness (i.e., marriage counseling); and healthy nutritional or dietary habits (i.e., Weight Watchers visits with nutritional specialist); can be monitored and used to assess financial incentives to be presented to an insurance member.

In one embodiment, monitoring of non-exercise related health-promoting measures entails recordation of member attendance at meetings or facilities related to wellness. Recordation of member attendance can be carried out via mechanical, computerized, or manual means, or any combination thereof. For example, member attendance can be recorded by, but not limited to, a person who manually writes down the name and time of member attendance; a computerized system that includes an event indicator (i.e., an event indicator monitor that can determine whether the user has performed a prescribed event) and an identification means; or a mechanical device such as a punch ticket machine that will provide verification of member attendance. In any event, only individuals authorized to access and input responsible data will be allowed to vouch for performance.

Non-limiting examples of wellness related meetings or facilities include rehabilitation facilities, weight control facilities/meetings (i.e., Jenny Craig or Weight Watchers), and meditation courses/yoga facility. Data regarding the attendance duration and/or participated activity can be recorded and communicated to a central computer.

Further, the present invention provides methods for recording member participation in wellness visits with a clinician. In one embodiment, clinical and/or attendance data regarding wellness visits can be communicated to the central computer of the invention. Wellness visits to access preventive care services such as regular measurements of body lipids (cholesterol, high-density lipoprotein (HDL), low-density lipoprotein (LDL), triglycerides), glucose, blood pressure, heart rate, weight, and body fat; annual analysis of pap smears, blood, urine, and saliva; annual physical examination; breast and gynecological examination; prostate examination; and vaccinations (i.e., flu shots) can be recorded by the clinician and communicated to the central computer.

Communication devices such as wireless interfaces, cable modems, satellite links, microwave relays, and traditional telephonic modems can transfer monitored data from either an exercise machine, a personal monitoring device, an exercise facility, a gatekeeper, or a recordation means from a non-exercise meeting or facility to a central computer via a electronic communication (such as a network), oral communication (such as a telephone), in person communication, facsimile communication, or written communication. Networks available for electronic transmission of data include, but are not limited to, local area networks, intranets and the open Internet. A browser interface, for example, NETSCAPE NAVIGATOR or INTERNET EXPLORER, can be incorporated into communications software to view the transmitted data.

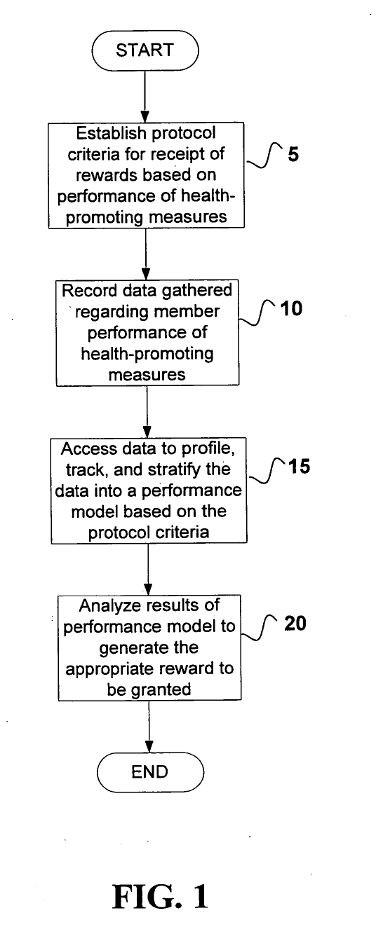

In accordance with the subject technology, as illustrated in FIG. 1, protocol criteria for receipt of financial incentives for member performance of health-promoting measures are established 5. Protocol criteria can be established by any entity that has appropriate knowledge or access to knowledge regarding human well-being and health including, but not limited to, an insurance carrier, a health professional, a governmental entity, self insured entity or any combination thereof.

Once the protocol criteria are established, they are presented to the insurance member. In one embodiment, the insurance member can select a protocol criteria level he or she wishes to perform from various levels of “performance” criteria. In another embodiment, the insurance carrier can select a protocol criteria level that an insurance member must perform to receive any/all incentives offered.

Each member's recorded data in relation to activities associated with health-promoting measures 10 are stored in a central computer. A statistical data management continuum program of the central computer is initiated upon receipt of recorded member data. The statistical data management continuum program establishes a file for each member, in which the member's vital health statistics and prescribed exercise regimen are profiled, tracked, and stratified into a performance model based on protocol criteria 15. Each protocol criteria level is associated with a specific financial incentive (i.e., discounted premium payments). Based on protocol criteria level, either established or chosen, the member's compliance is monitored. For example, the member's historical attendance along with individual performance data including, but not limited to, type of exercise performed; intensity level, number of repetitions, are documented, recorded, and loaded onto a computer-based system.

In certain embodiments, all activity to be monitored (i.e., physical activity monitored by an exercise machine or a personal monitoring device of the invention) can be ‘benchmarked’ at the onset using a personal trainer to verify activities and the affect of same on caloric burn in a member.

In a related embodiment, where the physiological status data to be monitored by a personal monitoring device of the invention is the amount of calories burned, it is the ‘variance’ between resting/normal caloric burn and ‘activity-based’ caloric burn that will be recorded by the sensor(s) of the personal monitoring device. Such data can be used in accordance with the subject invention to provide evidence that the member is actively participating and complying with health promoting activities.

The cumulative results from the member's performance data are then summarized (i.e., “Protocol Compliant Assessment Summary”) to assess if and how much of a reward (also referred to herein as financial incentive) will be provided to the member 20. This summary can be generated by the central processing unit of a centralized computer of the insurance carrier or of the gatekeeper who periodically transmits a continuous coverage assessment to an insurer, who will then assess whether and to what degree a reward is to be given to a member.

In one embodiment, protocol activity summaries will remain stored in the central computer and can be transferred to interested parties throughout the life of the member. This way, should a member move from one insurer to another, the stored summaries can be accessed by the new carrier to assess an activity component which might affect premium rate determinations.

There are a variety of rewards (or financial incentives) available to insurance carriers to encourage members to participate in health-promoting measures. Suitable rewards include, and are not limited to, discounting insurance premiums, decrease cost of member copayments; payment of bonuses; and subsidization and/or payment of fees associated with performing health-promoting measures (i.e., subsidized health club membership).

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other means by which a human can input data into a computer, including through other programs such as application programs.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method for providing incentives from an insurance carrier to an insurance member to perform health-promoting measures comprising:
a) assessing the insurance member's health;
b) establishing a list of at least one health-promoting measure and at least one financial incentive to be presented to the insurance member based on the assessment of health;
c) monitoring the insurance member's compliance in performing said at least one health-promoting measure; and
d) assessing the appropriate at least one financial incentive to be presented to the insurance member based on monitored compliance.

2. The method according to claim 1, wherein the at least one health-promoting measure is selected from the group of activities consisting of exercise performed; activities dedicated to improving or maintaining mental and emotional balance and health; activities dedicated to improving or maintaining relationship wellness; and activities dedicated to improving or maintaining nutritional or dietary habits.

3. The method according to claim 2, wherein the at least one health-promoting measure is a combination of the group of activities.

4. The method according to claim 2, wherein the exercise is performed on an exercise machine, and wherein the exercise machine is selected from the group consisting of stationary bicycles, stair climbers, steppers, rowing machines, ski machines, treadmills, cross trainers, hiking machines, abdominal exercise machines, elliptical exercise machines, and strength-training and weight machines.

5. The method according to claim 4, wherein the health-promoting measure is exercise performed on the exercise machine and the step of monitoring the insurance member's compliance in using the exercise machine further comprises the steps of recording the identity of the individual using the exercise machine, and monitoring the type of exercise being performed by the individual; the intensity and duration of exercise, and the member's physiological conditions.

6. The method according to claim 2, wherein the activity directed to improving or maintaining mental and emotional balance and health comprises attending meditation courses or yoga classes.

7. The method according to claim 6, wherein the health-promoting measure is the activity directed to improving or maintaining mental and emotional balance and health, wherein the step of monitoring the insurance member's compliance in improving or maintaining mental and emotional balance and health comprises recording member attendance.

8. The method according to claim 2, wherein the activity directed to improving or maintaining nutritional dietary habits comprises meetings to address weight control meetings, or visits with a nutritional specialist.

9. The method according to claim 1, wherein the health-promoting measures are wellness visits with a clinician.

10. The method according to claim 1, further comprising the step of selecting the health-promoting measures to be performed by the member.

11. The method according to claim 11, wherein the member selects the health-promoting measures to be performed by the member.

12. The method according to claim 11, wherein the insurance carrier selects the health-promoting measures to be performed by the member.

13. The method according to claim 1, wherein the financial incentives are selected from the group consisting of discounted insurance premiums, decreased cost of member co-payments, payment of bonuses, subsidization of fees associated with performing the health-promoting measure, and payment of fees associated with performing the health-promoting measure.

14. A system for providing cost-effective insurance coverage to insurance members and promoting healthy insurance members, said system comprising:
a) a means for monitoring an insurance member's performance of at least one health-promoting measure;
b) a centralized computer;
c) a means for communicating monitored performance of at least one health-promoting measure to the centralized computer; and
d) a means for assessing appropriate financial incentives to be presented to the insurance member based on monitored performance.

15. The system according to claim 14, wherein the means for monitoring the insurance member's performance is an exercise machine comprising a monitoring means and a means for recording the identity of the insurance member.

16. The system according to claim 14, wherein the centralized computer comprises a central processing unit.

17. The system according to claim 16, wherein the central processing unit performs program codes for a statistical data management continuum program.

18. The system according to claim 16, wherein the central processing unit performs program codes to summarize the member's performance of the at least one health-promoting measure.

19. The system according to claim 14, wherein the at least one health-promoting measure is a non-exercise related health-promoting measure and the means for monitoring comprises a recordation means.

20. The system according to claim 19, wherein the recordation means is selected from the group consisting of a person, a computerized system, or a mechanical device.

21. The system according to claim 14, wherein the financial incentives are selected from the group consisting of discounted insurance premiums, decreased cost of member copayments, payment of bonuses, subsidization of fees associated with performing the health-promoting measure, and payment of fees associated with performing the health-promoting measure.

22. The system according to claim 14, wherein the means for monitoring the insurance member's performance is a personal monitoring device that comprises at least one sensor and a transmitter.

23. The system according to claim 22, wherein the personal monitoring device further comprises a means for recording the identity of the insurance member.

24. A computer readable medium containing program instructions for displaying member data on a display device of a computer system, the data being obtained from tables in a database associated with the computer system, said computer readable medium comprising:
first computer program code for receiving data regarding a member's health;
second computer program code for establishing a list of at least one health-promoting measure and at least one financial incentive to be presented to the insurance member based on the assessment of health;
third computer program code for assessing the insurance member's health;
fourth computer program code for monitoring the insurance member's compliance in performing said at least one health-promoting measure based on assessment of health; and
fifth computer program code assessing the appropriate at least one financial incentive to be presented to the insurance member based on monitored compliance.
